(19) United States
(12) Patent Application Publication
(10) Pub. No.: US 2004/0180266 A1
(43) Pub. Date: Sep. 16, 2004

(54) Optical recording medium and method of manufacturing optical recording medium

(75) Inventors: Akiko Hirao, Chiba (JP); Kazuki Matsumoto, Kanagawa (JP); Katsutaro Ichihara, Kanagawa (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/775,060

(22) Filed: Feb. 11, 2004

(30) Foreign Application Priority Data
Mar. 12, 2003 (JP) 2003-066767

(51) Int. Cl. G03H 1/04

(52) U.S. Cl. 430/1; 430/2; 369/3

(57) ABSTRACT

A holographic optical recording medium includes a plastic substrate, a first inorganic intermediate layer formed on the plastic substrate, and an organic recording layer on which information is recorded by using holography. The organic recording layer is formed on the first inorganic intermediate layer.

### CROSS-REFERENCE TO RELATED APPLICATIONS

This application is based upon and claims the benefit of priority from the prior Japanese Patent Applications No. 2003-066767 filed on Mar. 12, 2003 the entire contents of which are incorporated herein by reference.

### BACKGROUND OF THE INVENTION

1) Field of the Invention

The present invention relates to a holographic optical recording medium and a method of manufacturing the holographic optical recording medium.

2) Description of the Related Art

A holographic storage has been known as an optical recording technology to realize recording with much higher density compared to the present recording technologies that are employed for recording on a magneto-optical recording medium and a phase-change optical recording medium.

Regarding the holographic storage, the research and development of a technology to realize transferring with large capacity and high speed by recording of a hologram has been carried out actively.

So far, angular multiplexing in the transmission geometry has been employed in the holografic storage. Realization of an extremely large storage capacity is an advantage of the angular multiplexing in the transmission geometry. However, with regard to an optical system, vibration removal has to be taken into consideration to achieve stable recording of optical interference pattern, highly accurate mechanical components and a positioning mechanism are necessary, and a double-beam interference method is required. If the optical system is to be structured to fulfill these requirements, the compactness and low cost of the optical system cannot be maintained, which is a drawback. As for the recording medium that is to be installed, a recording disc requires flatness of the order of the optical wave and it is incomplete as a system that enables to rewrite without a notion of address for holographic recording etc. in the recording medium. Thus, the recording medium is not compatible with the existing optical discs, which is a draw back.

In recent years, collinear holographic recording system in reflection geometry has been proposed to solve the problems in the angular multiplexing in the transmission geometry (for example, see Japanese Patent Laid-open No. 2002-123949).

In the collinear holographic recording and reproduction in reflection geometry, a medium in which a reflection surface is deposited on a reverse side of a transparent substrate and a hologram recording layer is deposited on a front surface of the substrate, is used. In the collinear holographic recording and reproduction in reflection geometry, during recording, recording beam and reference beam are irradiated coaxially from a front surface. During reproduction, only the reference beam is irradiated from the front surface and light diffracted upon irradiation is detected at the front of the surface.

In the collinear holographic recording and reproduction in reflection geometry, there can be many components in common in an incidence optical system and detection optical system. This results in an advantage that the problem of position adjustment of the optical system like the transmission optical system becomes less important.

Moreover, in the collinear holographic recording and reproduction in reflection geometry, shift multiplexing method can be used. For example, in a case of a recording area having a diameter of 100 μm, if (the recording area) is shifted by about 10 μm from a recording position (center position) in which interference fringes corresponding to certain information are recorded, then it is possible to record interference fringes corresponding to another information. In this case, since the information is recorded as a concentric circular wave front with a focal position as a center, the tolerance of amount of shift is wide. As a result, compatibility with digital versatile disc (DVD) and compact disc CD can be achieved.

However, to turn the holographic recording system into a product for household use, a low price plastic substrate is to be used as a substrate of the medium.

An organic recording layer that includes a material like a photopolymer for which the refractive index is modulated by polymerization of a monomer due to photoirradiation, a photorefractive polymer for which the refractive index is modulated by space charge distribution due to photoirradiation, and a photochromic material for which the refractive index is modulated by isomerization due to photoirradiation, is used as the hologram recording layer.

Thus, a holographic optical recording medium can be considered to be formed by a combination of the plastic substrate and the organic recording layer. However, inventor(s) of the present invention while making the present invention discovered the fact that when the reflex polar collinear recording generation is employed, use of the combination of the plastic substrate and the organic recording layer results in increase in a bit error rate during reproduction.

### SUMMARY OF THE INVENTION

It is an object of the present invention to provide a holographic optical recording medium in which a plastic substrate and an organic recording layer are used and a bit error rate during reproduction can be maintained low, and a method of manufacturing of the holographic optical recording medium.

A holographic optical recording medium according to one aspect of the present invention includes a plastic substrate that has a first surface and a second surface; a first inorganic intermediate layer formed on the first surface of the plastic substrate; and an organic recording layer in which information is recorded by using holography, the organic recording layer being formed on the first inorganic intermediate layer.

A method of manufacturing a holographic optical recording medium according to another aspect of the present invention includes forming a multilayered film that includes an organic recording layer that has a first surface and a second surface, a first inorganic intermediate layer on the first surface of the organic recording layer, a first transparent resin layer on the first inorganic intermediate layer, a second inorganic intermediate layer on the second surface of the organic recording medium, a second transparent resin layer on the second organic intermediate layer; and sticking the multilayered film to a plastic substrate by an adhesive.

A method of manufacturing a holographic optical recording medium according to still another aspect of the present invention includes forming an inorganic intermediate layer on a first surface of a plastic substrate; and forming an organic recording layer on the inorganic intermediate layer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a cross sectional view of a holographic optical recording medium according to an embodiment of the present invention;

FIG. 2 is a cross sectional view of an example of transformation of the optical recording medium shown in FIG. 1;

FIG. 3 is a cross sectional view of another example of transformation of the optical recording medium shown in FIG. 1;

FIG. 4 is a cross sectional view of a transmission optical recording medium;

FIG. 5 is an illustration of a method of recording information in the optical recording medium in FIG. 1;

FIG. 6 is an illustration of reproduction of information that is recorded in the optical recording medium in FIG. 1; and

FIG. 7 is an illustration of a recording and reproduction unit that can perform the recording in FIG. 5 and reproduction in FIG. 6.

### DETAILED DESCRIPTION

Exemplary embodiments of the present invention will be explained in detail below with reference to the accompanying drawings. Components that are shown in diagrams having similar or identical functions are indicated by same reference numerals and repeated descriptions are omitted.

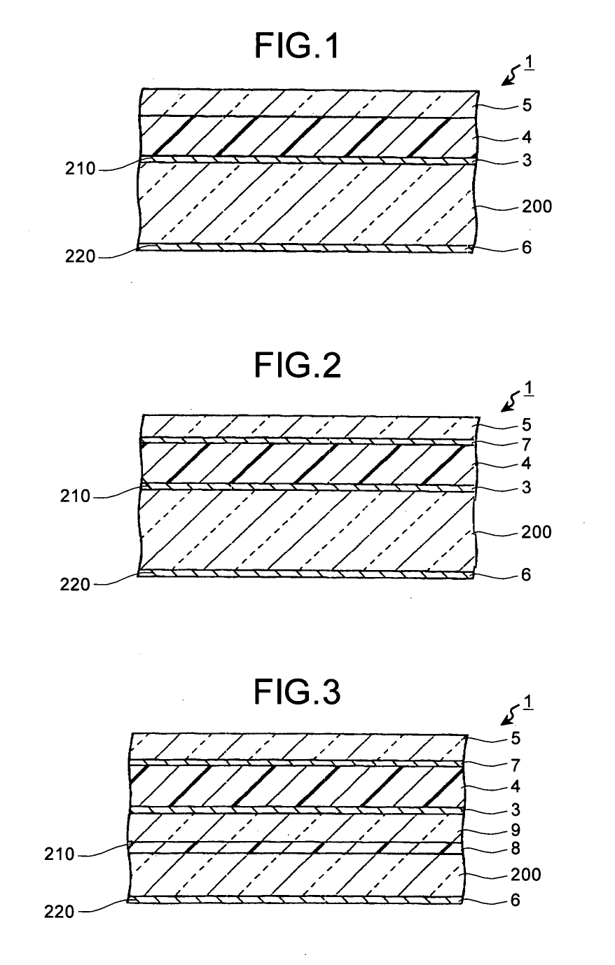

FIG. 1 is a cross sectional view of a holographic optical recording medium according to an embodiment of the present invention. An optical recording medium 1 in FIG. 1 includes a plastic substrate 200 that has a first surface 210 and a second surface 220. An inorganic intermediate layer 3, an organic recording layer (hologram recording layer) 4, and a protective layer 5 are deposited one after the other on the first surface 210. A reflective layer 6 is deposited on the second surface 220. Therefore, the optical recording medium 1 is a optical recording medium for reflection geometry.

The inorganic intermediate layer 3 and the protective layer 5 in the present embodiment form an inorganic intermediate layer and an organic transparent resin layer respectively according to an aspect of the present invention.

Inventor(s) of the present invention carried out various experiments to examine reasons for decrease in signal to noise ratio (SN ratio) during reproduction, when a plastic substrate and an organic recording layer are used while employing the collinear holographic recording and reproduction in reflection geometry. Following facts were discovered as a result of these experiments.

Typical photopolymers that can be used as a material for the hologram recording layer are materials that are formed by polymerization of monomers that are low molecular weight compounds due to generation of acid by an acid generating agent or due to generation of a radical by a radical generating agent, upon photoirradiation. Therefore, the hologram recording layer that includes such materials has low molecular organic compounds like monomers. A plastic substrate, in general, includes low molecular weight compound like a plasticizer and a mould releasing agent.

For this reason, if the organic recording layer that is formed by a photopolymer etc. is deposited directly on the plastic substrate, low molecular weight compounds diffuse in bulk of the plastic substrate and the photopolymer. The monomer or the acid, which diffuse in the plastic substrate from the organic recording layer, affects smoothness and transparency of the plastic substrate. On the other hand, diffusion of the plasticizer or the mould releasing agent from the plastic substrate to the organic recording layer deteriorates the sensitivity of the organic recording layer and shortens the life of recording.

However, it is a known fact that closer the solubility parameters of the two plastic materials, it is easier to adhere the plastic materials firmly. Therefore, to stick the organic recording layer formed by the photopolymer, firmly to the plastic substrate, materials, which have closer solubility parameters are used for the organic recording layer and the plastic substrate or an adhesive layer formed by a material that has solubility parameters closer to those of the organic recording layer and the plastic substrate is provided between the organic recording layer and the plastic substrate. However, in any of the two cases, due to close solubility parameters, there is a remarkable deterioration of characteristics due to the scattering of the low molecular weight compound.

The diffusion of the low molecular weight compound from the organic recording layer to the plastic substrate and vice versa, or from the organic recording layer to the adhesive layer and vice versa, and from the plastic substrate to the adhesive layer and vice versa, may cause a problem of increasing the bit error rate during reproducing in the holographic recording by transmission angular multiplexing as well as in the holographic recording by the reflex polar collinear recording. The increase in the bit error rate during reproduction due to the diffusion of the low molecular weight compound causes a major problem in the reflex polar collinear recording, whereas in the transmission angular multi-recording the problem is not as major as in the reflex polar collinear recording. The reason is described below.

In the holographic recording by reflex polar collinear recording, unlike in the holographic recording by transmission angular multiplexing, both the recording beam and the reference beam are transmitted twice through an interface between the organic recording layer and the plastic substrate. Since the recording beam and the reference beam are transmitted through the interface that is disordered due to the diffusion of the low molecular weight compound, the diffusion of the beams due to the disordered interface affects the reproduction remarkably as compared to a case in which transmission angular multiplexing is used. Concretely, a ghost is recorded during recording the hologram. As a result, the SN ratio is deteriorated.

The diffusion of the low molecular weight compound from the organic recording layer to the plastic substrate and vice versa, or from the organic recording layer to the adhesive layer and vice versa, and from the plastic substrate to the adhesive layer and vice versa occurs when a material like a photopolymer, a photo refractive polymer, and a photochromic material is used. The diffusion is most remarkable when a photopolymer is used.

To deal with this problem, in the optical recording medium 1 according to the present embodiment, the inorganic intermediate layer 3 is provided between the plastic substrate 200 and the organic recording layer 4. The inorganic intermediate layer 3 obstructs the movement of the low molecular weight compound between the plastic substrate 200 and the organic recording layer 4. As a result, according to the present embodiment, the disorder in the interface caused due to the diffusion of the low molecular weight compound cannot occur easily and recording of the ghost during recording of the hologram can be suppressed. In other words, this enables to control the bit error rate low during reproduction.

The thickness of the plastic substrate 200 according to the present embodiment is from few ten micrometers to one millimeter. The so-called engineering plastic which is transparent and has high mechanical strength is a desirable material for the plastic substrate 200. Examples of typical material for the plastic substrate 200 are polycarbonate resins, norbornene resins, cycloolefin resins, polyalylate, polymethyl methacrylate, polystyrene, poly (ethylene dimethylacrylate), polydiethylene glycol bis (allyl carbonate), polyphenylene oxide, polyethylene terephthalate.

Examples of materials desirable for the inorganic intermediate layer 3 are magnesium fluoride, calcium fluoride, zirconium fluoride, palladium fluoride, barium fluoride, cesium bromide, cesium iodide, magnesium oxide, aluminum oxide, silicon oxide, titanium oxide, chromium oxide, zinc oxide, yttrium oxide, zirconium oxide, indium oxide, tin oxide, tellurium oxide, cerium oxide, hafnium oxide, tantalum oxide, boron nitride, silicon nitride, aluminum nitride, zirconium nitride, silicon carbide, zinc sulfide, barium titanate, and diamond.

A material that has high transmittance of the recording beam or servo beam and has a refractive index close to that of the organic recording layer 4 and the plastic substrate 200 is desirable to be used as a material for the inorganic intermediate layer 3. Particularly, it is better to have the transmittance of the recording medium as high as possible. The desirable transmittance of the recording beam in the intermediate layer is not less than 90 percent. It is desirable that the transmittance of the servo beam is not less than 50 percent. The transmittance has to be sufficient for detecting the servo beam that is transmitted or reflected for servo.

The inorganic intermediate layer 3 is generally formed in a form of a continuous film (membrane). Such formation exerts the effect of suppressing the diffusion of the low molecular weight compound. From point of view of prevention of occurrence of pinhole effect, it is desirable that the thickness of the inorganic intermediate layer 3 is not less than 1 nm. It is desirable to determine the thickness of the inorganic intermediate layer 3 based on the material and method of formation of the inorganic intermediate layer 3. There is no upper limit to the thickness of the inorganic intermediate layer 3. However, making of inorganic intermediate layer 3 excessively thick results in rise in the manufacturing cost, which is not desirable. From the cost point of view, it is desirable that the thickness of the inorganic intermediate layer 3 is not greater than about 2000 nm.

The organic recording layer 4 includes an organic compound that can record interference fringes. The organic recording layer 4 includes a material in which the main optical characteristics like refractive index etc. vary according to changes that take place upon optical irradiation.

A material that is polymerized due to polymerization reaction upon photoirradiation is desirable to be used as a material for the organic recording layer 4. Photopolymers are examples of such material.

Polymers and monomers that are matrices and compositions which include photoinitiators are desirable to be used as the photopolymer in the organic recording layer 4.

A method in which the diffusion of low molecular weight compounds is used can be employed as a method for varying the optical characteristics by irradiating the recording beam on the photopolymer. For relaxation of change in volume during polymerization, diffusion elements may be added in a direction opposite to that of the polymerization elements. Or, a compound that has an acid cleavage structure may be added separately apart from a polymer.

When the organic recording layer 4 is formed by a photopolymer that includes a low molecular weight component, the organic recording layer 4 is structured such that it can contain a liquid if required.

If the compound that includes the acid cleavage structure is added, the change in volume may be suppressed by compensating the expansion resulted due to the cleavage with the contraction resulted due to the polymerization of a monomer.

A monomer that has an acrylate reactive group can be used as a photopolymer.

Concretely, the desirable examples of monomers having an acrylate reactive group are isobornyl acrylate, phenoxyethyl acrylate, diethylene glycol, monoethyl ether acrylate, and ethyl acrylate.

Moreover, polyfunctional acrylates such as pentaerythritol triacrylate, trimethylolpropane triacrylate, dipentaerythritol pentahexaacrylate, ditrimethylolpropane tetraacrylate, and pentaerythritol tetraacrylate, are desirable.

From point of view of increasing refractive-index modulation, acrylates such as 2-naphtho-1-oxyethyl acrylate, and 2-carbazole-9-ylethyl acrylate, can also be used. Acrylates having low refractive index such as (trimethyl silyloxy) dimethyl silylpropyl acrylate, and (perfluorocyclohexyl) methyl acrylate, are desirable.

Vinyl benzoate, vinyl 3,5-dichlorobenzoate, vinyl 1-naphthoate may also be used. Further, N-vinyl carbazole may also be used.

It is desirable to use a material that shows sufficient sensitivity for the recording beam as a photoinitiator in the photopolymer. In other words, a material that causes radical polymerization or a material that causes cationic polymerization upon photoirradiation is desirable. Radical generating agents such as bis(2,6-difluoro-3-pyrrolylphenyl) titanocene, bis(2,4,6-trimethylbenzoyl)-phenyl phosphine oxide, bis(2,4-cyclopentadiene-1-yl-bis(2,6-difluoro-3-(1H-pyrrole-1-yl)-phenyl) titanium, a mixture of bis(2,6-dimethoxybenzoyl)-2,4,4-trimethyl-pentyl phosphine oxide and 1-hydroxy-cyclohexyl-phenyl-ketone, 2-methyl-1[4-(methylthio)phenyl]-2-morpholynopropane-1-one, and 2-benzyl-2-diomethylamino-1-(4-morpholinophenyl)-butanone-1, are desirable.

A photopolymer can be obtained by mixing and stirring these materials. The organic recording layer 4 is deposited by casting this photopolymer.

A material that shows photo refractive effect, in other words a material in which the refractive index is modulated due to space charge distribution upon photoirradiation is desirable as a material for the organic recording layer 4. Organic photo refractive materials are such materials.

It is desirable to use a composition that includes a charge transport material, a charge generating material, and a nonlinear optical material as the organic photo refractive material that can be used in the organic recording layer 4. Any material that includes only a low molecular weight material or a material that includes a high molecular weight material may be used, provided that the material shows the photo refractive effect.

The charge generating material generates charge upon absorbing the recording beam. In other words, the charge generating material is an absorber of the recording beam. If a charge transport material that has high optical density of the recording beam is used, the recording beam sometimes does not reach the charge generating material that is deep. From the point of view of absorption of the recording beam, it is desirable to select the charge generating material and to adjust the optical density in a range of 10⁻⁶ cm⁻¹ to 10 cm⁻¹.

The desirable examples of the charge generating material that can be used with the organic photo refractive material are metallic phthalocyanine, nonmetallic phthalocyanine, phthalocyanine coloring matter or phthalocyanine pigments of derivatives of metallic and nonmetallic phthalocyanine, naphthalocyanine coloring matter or naphthalocyanine pigments, coloring matter or pigments of azo like monoazo, disazo, trisazo etc., dye or pigments of perylene, dye or pigments of indigo, dye or pigments of quinacridone, dye or pigments of polycyclic quinones like anthraquinone, anthoanthrone etc., charge transfer complexes that are composed of electron acceptors and electron donors, like typical TTF-TCNQ, salts of azulenium, fullerenes like typical C₆₀ and C₇₀ and methanofullerenes that are derivatives of fullerenes. Among these materials, the charge transfer complexes are desirable as a material in the organic recording layer 4 of the recording medium 1 according to the present embodiment.

The charge transport material is either a hole transport material or an electron transport material. Low molecular compounds and high molecular compounds are desirable as a charge transport material that can be used in the organic photo refractive material. If the charge transport material is a high molecular compound, the charge transport material may be a copolymer.

The examples of charge transport material that can be desirably used in the organic photo refractive material are nitrogenous cyclic compound like indole, carbazole, oxazole, isoxazole, thiazole, imidazole, pyrazole, oxadiazole, pyrazolone, thiazole, triazole, or derivatives of these nitrogenous compounds, or compound having these nitrogenous cyclic compounds in their main chain or side chain, hydrazone compounds, triphenyl amines, triphenyl methanes, butadienes, stilbenes, quinone compounds like anthraquinone diphenoquinone or derivatives of quinone compounds or compounds having these quinone compounds in their main chain or side chain, fullerenes like typical C₆₀ and C₇₀ and their derivatives. π-conjugated polymers like polyacetylenes, polypyrroles, polythiophenes, polyanilines, σ-conjugated polymers like oligomers, polysilanes, polygermanes, and polycyclic aromatic compounds like oligomers, anthracenes, pyrenes, phenanthrenes, coronenes may be used as the charge transport material.

A material in which the molecules are isomerized upon photoirradiation and the refractive index is modulated is desirable to be used in the organic recording layer 4. Photochromic materials are examples of such material.

The photochromic material is a material that initiates photochromic reaction. Photochromic reaction is a reaction in which there is a change due to light and the reaction includes various structural changes like those due to isomerization, opening and closing of ring, ionization, and hydrogen transfer.

The examples of the desirable organic photochromic material that can be used in the organic recording layer 4 are azobenzene compounds, stilbenes compounds, indigo compounds, thioindigo compounds, spiropyrane compounds, spirooxazine compounds, fulgide compounds, anthracene compounds, hydrazone compounds, and compounds of cinnamic acid. Among these organic photochromic materials, the derivatives of azobenzene and stilbenes that undergo change due to cis-trans isomerism upon photoirradiation are particularly desirable. The derivatives of spiropyrane and spirooxazine that undergo structural change due to opening and closing of ring upon photoirradiation are also particularly desirable organic photochromic materials.

The protective layer 5 need not be provided necessarily. However, from the point of view of mechanical protection of the organic recording layer 4, it is desirable to provide the protective layer 5. Examples of a material that can be used in the protective layer 5 are transparent materials like glass, transparent resins, and materials that are used in the inorganic intermediate layer 3.

To prevent the organic recording layer 4 from deterioration due to natural light and to improve the shelf life of the organic recording layer, it is desirable to include in the protective layer 5 a film (membrane) that has a high sensitivity photo bleaching function or a film (membrane) that has a high sensitivity photochromic function. Since the organic recording layer 4 is in quasi-stable state with dispersed monomer, the organic recording layer 4 is deteriorated due to natural light. However, since the organic recording layer 4 after the recording is in a stable state having a polymerized monomer corresponding to an interference pattern, even without the protective layer 5, archival life is not affected.

As for the reflective layer 6, it is desirable to use a material that has a high reflectivity of the recording beam and the reference beam. For example, if the wavelength of light that is used is in a range of 400 nm to 780 nm, it is desirable to use an alloy of Al or Ag. If the wavelength of light is not less than 650 nm, it is desirable to use an alloy of any one of Al, Ag, Au, and Cu or tin. The desirable thickness of the reflective layer 6 is not less than 50 nm to enable to realize sufficient the reflectivity; and thickness not less than 100 nm is more desirable.

The optical recording medium 1 shown in FIG. 1 can be manufacture by the following method. To start with, the inorganic intermediate layer 3 is deposited by a method like sputtering on the first surface 210 of the plastic substrate 200. The organic recording layer 4 is provided on the inorganic intermediate layer 3 by a method like casting. A transparent substrate it stuck firmly on the organic recording layer 4 as a protective layer 5 or a thin transparent film (membrane) is deposited as a protective layer 5 on the organic recording layer 4. Further, the reflective layer 6 is deposited by a method like sputtering on the second surface 220 of the plastic substrate 200. The reflective layer may be deposited at any stage of the process. Thus, the optical recording medium 1 shown in FIG. 1 is prepared.

For including the organic photo refractive material in the organic recording layer 4, a solution is prepared by dissolving the charge generating material and charge transport material in a solvent. A film is deposited by applying this solution. The solvent is evapolated from the film that is formed and the organic recording layer 4 is deposited.

In another method for preparing the organic recording layer 4, an organic photo refractive material that is fluidized by heating is applied to form a film. The film applied is cooled quickly and the organic recording layer 4 is deposited.

Various transformations of the optical recording medium 1 shown in FIG. 1 are possible. In one of the examples of such transformations, to start with, the plastic substrate 200 is deposited on the reflective layer 6. The inorganic intermediate layer 3 and the organic recording layer 4 are deposited one after the other on the plastic substrate 200 that is deposited on the reflective layer 6.

In a case where the reflective layer 6 is deposited on the organic recording layer 4 after the organic recording layer 4 is deposited on the plastic substrate 200, due to the sputtering while forming the reflecting layer 6, there is a change in the characteristics of molecules that are included in the organic recording layer 4, which is not favorable. To deal with this, according to the process that is applied in the example of transformation, the organic recording layer 4 is deposited after forming the reflective layer. This enables to avoid the change in the characteristics of the molecules.

Regarding the inorganic intermediate layer 3, similarly as in the organic recording layer 4, there is a possibility of change in characteristics in the process of forming the reflective layer 6. For this reason, it is desirable to form the inorganic intermediate layer 3 after forming the reflective layer 6.

FIG. 2 is a cross sectional view of the example of transformation of the optical recording medium 1 shown in FIG. 1. The optical recording medium 1 shown in FIG. 2 includes an inorganic intermediate layer 7 between the organic recording layer 4 and the protective layer 5. Thus, the optical recording medium 1 in FIG. 2 differs from the optical recording medium 1 in FIG. 1. Apart from the inorganic intermediate layer 7, the structure of the optical recording medium 1 in FIG. 2 is similar to that of the optical recording medium 1 in FIG. 1. The inorganic intermediate layer 7 according to the present embodiment is a second inorganic intermediate layer according to one of the aspects of the present invention.

The inorganic intermediate layer 7 is deposited by the same material as that in the inorganic intermediate layer 3 and functions similarly to the inorganic intermediate layer 3. Therefore, if the protective layer 5 is formed by a transparent resin layer like a transparent plastic substrate, the migration of the low molecular weight compound between the organic recording layer 4 and the protective layer 5 can be obstructed. Due to this, the disorder in the interface due to the diffusion of the low molecular weight compound cannot occur easily. As a result, the recording of a ghost during the recording of hologram and decrease in SN ratio can be suppressed effectively.

Thus, in the optical recording medium according to this example, since the organic recording layer 4 is sandwiched between the inorganic intermediate layers 3 and 7, the diffusion of the low molecular weight compound from the plastic substrate 200 and the protective layer 5 to the organic recording layer 4 can be suppressed.

The optical recording medium 1 shown in FIG. 2 can be manufactured by the following method. To start with, a transparent substrate like a plastic substrate is procured as the protective layer 5. The inorganic intermediate layer 7 is deposited by a method like sputtering on one surface of the protective layer 5. The inorganic intermediate layer 3 is deposited on the first surface 210 of the plastic substrate 200 by a method like sputtering.

Further, the organic recording layer 4 is deposited on the inorganic intermediate layer 3 by a method like casting. The inorganic intermediate layer 7 that is deposited on the transparent substrate is allowed to be in firm contact with the organic recording layer 4. The reflective layer 6 is deposited on the second surface 220 of the plastic substrate 200 by a method like sputtering. The reflective layer 6 can be deposited at any stage during the manufacturing process. Thus, the optical recording medium 1 shown in FIG. 2 is prepared.

FIG. 3 is a cross sectional view of another example of transformation of the optical recording medium 1 shown in FIG. 1. The optical recording medium 1 in FIG. 3 includes an adhesive layer 8 and a transparent resin layer 9 between the plastic substrate 2 and the inorganic intermediate layer 3. Thus, the optical recording medium 1 in FIG. 3 differs from the optical recording medium 1 in FIG. 2. Apart from the adhesive layer 8 and the transparent resin layer 9 between the plastic substrate 2 and the inorganic intermediate layer 3, the structure of the optical recording medium 1 in FIG. 3 is similar to that of the optical recording medium 1 in FIG. 2. The transparent resin layer 9 according to the present embodiment is a first transparent resin layer according to one of the aspects of the present invention.

As it is shown in FIG. 3, in the optical recording medium 1 according to this example, the adhesive layer 8 and the transparent resin layer 9 are deposited one after the other on the first surface 210 of the plastic substrate 200. The inorganic intermediate layer 3 is deposited on the transparent resin layer 9. It is desirable that the adhesive layer 8 and the transparent resin layer 9 are formed by a material that has low content of the low molecular weight compound.

Since the inorganic intermediate layer 3 and 7 are provided respectively on two sides of the organic recording layer 4 in the optical recording medium according to the present example, similarly as in the optical recording medium 1 shown in FIG. 2, the diffusion of the low molecular weight compound from the plastic substrate 200 etc. to the organic recording layer 4 is suppressed.

The adhesive layer 8 and the transparent resin layer 9 are formed by a material that has low content of the low molecular weight compound. Therefore, the diffusion of the low molecular weight compound from the adhesive layer 8 or the transparent resin layer 9 to the organic recording layer 4 does not cause a problem. Due to this, the disorder in the interface due to the diffusion of the low molecular weight compound cannot occur easily. As a result, the recording of a ghost during the recording of hologram and decrease in SN ratio can be suppressed effectively.

A solvent-vaporization adhesive, a hot-melt adhesive that uses a thermoplastic resin, a chemical reaction cured adhesive, a photo-curing material can be used in the adhesive layer 8.

In the structure in FIG. 3, the transparent resin layer 9 can be omitted. In this case, it is desirable to use a material like an epoxy resin, a urethane adhesive, and a second generation acrylic adhesive.

The optical recording medium 1 shown in FIG. 3 can be manufactured by the following method. To start with, a transparent resin layer like a plastic sheet is to be procured as the protective layer 5 and the transparent resin layer 9. The inorganic intermediate layers 7 and 3 are deposited on one surface of the transparent resin layers 5 and 9 respectively on one surface of the transparent resin layers 5 and 9 respectively by a method like sputtering. The inorganic intermediate layer 7 need not be provided necessarily. However, if the inorganic intermediate layer 7 is provided, when a transparent resin like transparent plastic is used as a material in the protective layer 5, the migration of the low molecular weight compound between the organic recording layer 4 and the protective layer 5 is obstructed.

Further, the organic recording layer 4 is deposited by a method like casting on either the inorganic intermediate layer 7 or the inorganic intermediate layer 3. The transparent resin layers 5 and 9 are stuck by using a roll etc. such that the inorganic intermediate layers 7 and 3 are face to face with the organic recording layer 4 sandwiched between the inorganic intermediate layers 7 and 3.

The multiple layered structured thus formed and the plastic substrate 200 are stuck to each other through the adhesive layer 8 by using a roll etc. The adhesive layer 8 is cured by photoirradiation and/or heating. The adhesive layer 8 need not be necessarily cured by the photoirradiation or heating. Applying of pressure by using a roll etc. can serve the purpose. It is desirable to perform these processes such that there is no considerable change in the optical characteristic of the organic recording layer 4.

The reflective layer 6 is deposited on the second surface 220 of the plastic substrate 200 by using a method like sputtering. The reflective layer 6 may be deposited at any stage of the manufacturing process. Thus, the optical recording medium 1 shown in FIG. 3 is prepared.

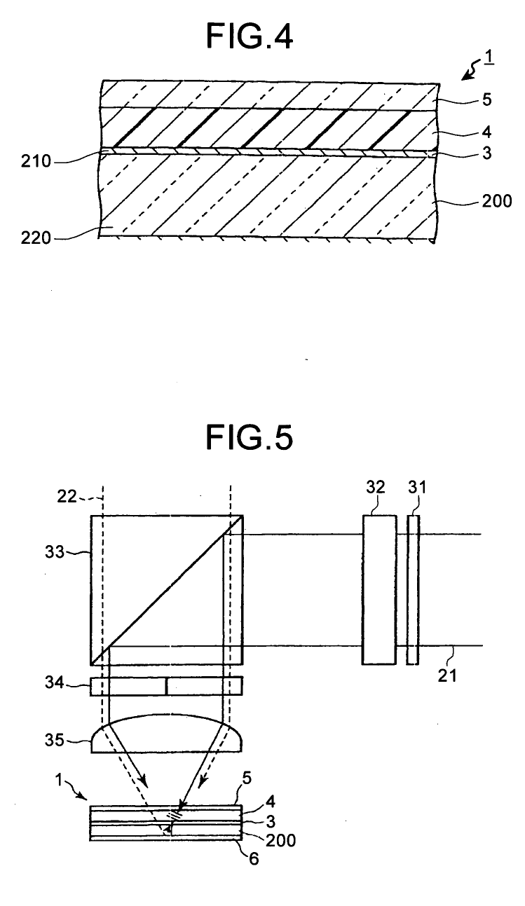

The medium for collinear holographic recording in reflection geometry is explained above. However, the optical medium may also be a optical recording medium for transmission geometry. FIG. 4 is a cross sectional view of the transmission optical recording medium. Here, the optical recording medium 1 does not include the reflective layer 6. Thus, the structure of the holographic recording medium for reflection geometry differs from that of the holographic recording medium for reflection geometry. The method of manufacturing of the holographic recording medium for transmissive geometry is the same as the method of manufacturing the holographic recording medium for the reflection geometry except for omission of a step of providing the reflective layer.

Moreover, there may be two patterns of the holographic recording medium for transmission geometry corresponding to two examples of transformation of the holographic recording medium for reflection geometry. In these cases also, the structure of a holographic recording medium 1 for transmission geometry differs from that of a reflex optical recording medium 1 at a point that the reflective layer 6 is not included. The methods of manufacturing the transmission optical recording medium 1 are the same as the methods of manufacturing the reflex optical recording medium 1 except for omission of a step of providing the reflective layer.

Further, a method of recording information in the optical recording medium 1 according to the present embodiment, a method of reproducing the recorded information, a recording and reproducing unit capable of recording and reproducing, and control methods are described below. The description is made by referring to an example of the optical recording medium 1 shown in FIG. 1. Recording, reproduction, and control in the optical recording media 1 that are shown in FIGS. 2 and 3 can be performed similarly.

FIG. 5 is an illustration of a method of recording information in the optical recording medium 1. A solid line 21 indicates the recording beam (s-polarized light) and a broken line 22 indicate the reference beam (p-polarized light).

An incidence system of the recording beam 21 includes a shutter 31 and a spatial light modulator (SLM) 32. An information signal is transmitted to the recording beam 21 by driving the SLM 32 corresponding to the information signal. The recording beam 21 of the s-polarized light is incident on a polarization beam splitter (PBS) 33 and is output from the PBS 33 towards the medium 1 with a change of angle by 90°. The recording beam 21 then passes through a gyrator 34.

According to the example in FIG. 5, the gyrator 34 which is a half split gyrator is set such that a right half of the gyrator 34 rotates a plane of polarization through +45° and a left half of the gyrator 34 rotates the plane of polarization through −45°. As a result, out of the recording beam 21 of the s-polarized light, light that passes through the right side of the gyrator 34 rotates the plane of polarization through s+45° and light that passes through the left side of the gyrator 34 rotates the plane of polarization through s−45°. Further the recording beam 21 passes through an object lens 35 and is condensed on an upper surface of the reflective layer 6 of the optical recording medium 1.

On the other hand, the reference beam 22 of the p-polarized light is incident from a top side of the PBS 33 and passes through the PBS 33 in a straight line. Out of the reference beam 22, light that passes through the right side of the gyrator 34 rotates the plane of polarization through p+45° and light that passes through the left side of the gyrator 34 rotates the plane of polarization through p−45°. Further, similar to the recording beam 21, the reference beam 22 passes through an object lens 35 and is condensed on the upper surface of the reflective layer 6 of the optical recording medium 1.

The planes of polarization of the recording beam 21 having the plane of polarization at s+45°, and of the reference beam having the plane of polarization at p−45°, match with each other. As a result, interference fringes are formed in the organic recording layer 4 as illustrated in FIG. 5.

In FIG. 5, to avoid complications, only the interference fringes due to the recording beam 21 that has the plane of polarization at s+45° and the reference beam 22 that has the plane of polarization at p−45° are shown. Since the recording beam 21 that has the plane of polarization at s−45° and the reference beam 22 that has the plane of polarization at p+45° have the same plane of polarization, interference fringes corresponding to the information signal are formed in the organic recording layer 4. In FIG. 5, incident light of the recording beam 21 at s+45° and reflected light of the reference beam at p−45° are shown to be interfering in right side of the organic recording layer 4. Reflected light of the recording beam 21 at s+45° and incident light of the reference beam 22 at p−45° interfere with each other in a left side of the organic recording layer 4.

Since the overall thickness of the substrate 200, the inorganic intermediate layer 3, and the organic recording layer 4 together is for example in a range of 100 μm to 1 mm, there is hardly any difference in optical paths of the recording beam 21 and according to the structure in FIG. 5, the reference beam 22 and information signals on upper side of the SLM 32 (incident on the right side of the gyrator 34) and on lower side of the SLM (incident on the left side of the gyrator 34) are recorded doubly on left and right sides of the organic recording layer 4. Since information patterns are different at an upper and a lower sides of the SLM 32, the double recording takes place. However, for both the upper and the lower sides of the SLM 32, since the same interference patterns are formed twice on the left and the right sides of the organic recording medium 4, there is no deterioration in signal quality as compared to that in the transmission angular multiple reproduction.

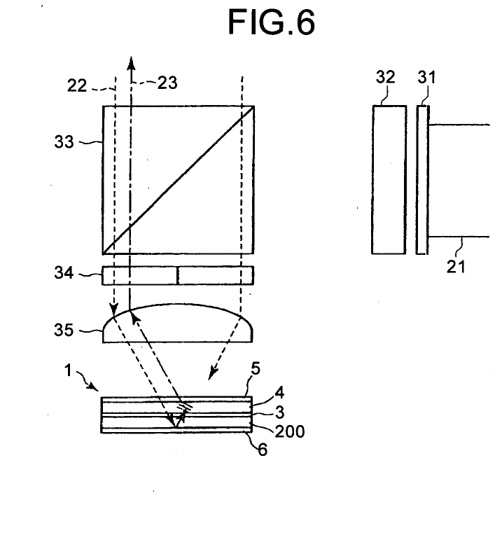

FIG. 6 is an illustration of reproduction of information that is recorded in the optical recording medium 1 in FIG. 1.

During reproduction, the shutter 31 in the incidence system of the recording beam 21 is closed. The shutter 31 is to be provided with a function of preventing incidence of the recording beam 21 on the recording medium 1 during reproduction. Any one of a liquid crystal shutter, an s-polarized light reflecting plate, and a total reflecting plate can be used as shutter 31. During reproduction, only the reference beam 22 of the p-polarized light is allowed to be incident.

In FIG. 6, for the sake of simplicity, illustration is made by putting emphasis on the reference beam 22 for reproduction that is incident from the left side of the PBS 33. The plane of polarization is rotated through p−45° due to passing of the incident p-polarized light through the left side of the gyrator 34. The p-polarized light then passes through the object lens 35 and incident on the recording medium 1 on which the interference patterns are recorded. In FIG. 6, to match with FIG. 5, the reflected light of the reference being 22 at p−45° being diffracted due to interference fringes is illustrated. Since the recorded interference fringes are formed by the recording beam 21 at s+45° and the reference beam 22 at p−45° as described in the method of recording, when the reference beam 22 at p−45° for reproduction is incident, the beam is refracted according to the interference fringes and returns to the object lens 35. Since diffracted beam 23 that is passed through the object lens 35 and the gyrator 34, passes through the gyrator 34 in a direction opposite to that of incidence, the plane of polarization rotates through +45°. As a result, the diffracted beam 23 becomes p-polarized light (=p−45°+45°), then passes through the PBS 33 in a straight line, and reaches a reproducing optical system (not shown in the diagram).

A part of light that is not diffracted at the interference pattern passes through a right side of the object lens 35 in a straight line. This light passes through the right side of the gyrator 34 from the lower side. As a result, the light becomes s-polarized light (=p−45°−45°). Due to this, the light cannot pass through the PBS 33 in a straight line and is turned towards the SLM 32 through 90°. Therefore, the light doesn't reach the reproducing optical system and does not become a noise source at all.

Moreover, a part of the light incident at p−45°, before reaching the reflective layer 6 is diffracted by the interference fringes that are formed in the left side of the organic recording layer 4 and contributes to the signal. In other words, both the diffracted beam 23 resulted from the diffraction of the reference beam 22 that is reflected from the reflective layer 6 and the diffracted beam resulted from the diffraction of the reference beam 22 that is not reflected from the reflective layer 6 become the reproducing light. As a result, the quality of the reproduced signal is improved. Out of the reference beam 22 for reproduction, light that is incident from the right side of the PBS 33, except when incident on the optical recording medium 1 as p+45° polarized light, moves similarly as the reference beam 22 for reproduction that is incident on the optical recording medium 1 as p−45° polarized light.

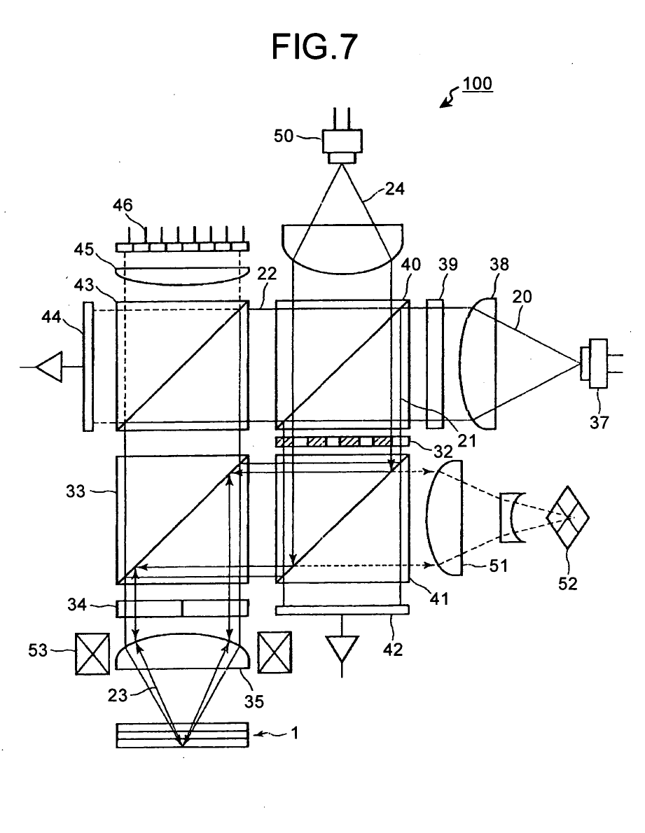

FIG. 7 is an illustration of a recording-reproducing unit that can perform the recording in FIG. 5 and reproduction in FIG. 6.

A recording-reproducing unit 100 that is shown in FIG. 7 includes a laser beam source that outputs a beam 20 having a long coherent length, which is suitable for holografic recording, as a light source 37 for recording-reproducing. Presently, the general light source that is most suitable for the holografic recording is a solid laser of wavelength 532 nm. However, Kr+ gas laser, semiconductor laser with an external resonator (wavelength for blue color to near-infrared can be selected freely and the typical wavelengths are 405 nm, 650 nm, 780 nm etc.), and semiconductor laser elements (LD) like DFB, DBR, and VCSEL having long coherent length without having an external resonator can also be used. Depending upon the laser source that is used as the light source 37, a beam-forming prism may be provided between the light source 37 and a lens 38.

The beam 20 that is emitted by the light source 37 becomes parallel after passing through the lens 38 and passes through a half-wave plate 39. A ratio of intensities of the recording beam 21 and the reference beam 22 can be adjusted by rotating the half-wave plate 39. It is desirable to match the intensities of s-polarized recording beam 21 and the p-polarized reference beam 22 that are incident on the optical recording medium 1 during recording. After passing through the half-wave plate 39, the beam 20 is incident on a PBS 40 and is split into s-polarized recording beam 21 and p-polarized reference beam 22.

The recording beam 21, then passes through the shutter 31 (omitted in FIG. 7) and the SLM 32, and is incident on a half mirror (HM) 41. A PBS or a total reflecting mirror can be used instead of the HM 41. It is desirable to use a PBS or a total reflecting mirror that can reflect almost whole of the s-polarized light, from the point of view of improving the efficiency of the recording medium 21. However, taking into consideration the other aspects, it is desirable to use the HM 41 and not the PBS or the total reflecting mirror. This is because, when the HM 41 is used, a part of the recording beam 21 is allowed to be incident on a photo detector (PD) 42 that detects the intensity of light information, thereby enabling to detect the intensity of the recording beam 21. The recording beam 21 for which the optical path is turned through 90° at the HM 41, is incident on the PBS 33 where the optical path is again turned through 900 and the recording beam 21 is incident on the optical recording medium 1.

On the other hand, the p-polarized reference beam 22 passes through the PBS 40 in a straight line and a part of the p-polarized reference beam 22 is turned at HM 43 through 900 towards the optical recording medium 1. The remaining part of the p-polarized reference beam 22 is incident on a reference beam PD 44 and is used for detecting the intensity of the reference beam 22. When it is possible to detect the intensities of the recording beam 21 and the reference beam 22 by using the PD 42 for the light information and the PD 44 for the reference beam, the azimuth of the half-wave plate 39 can be controlled such that the intensity of the recording beam 21 that is incident on the optical recording medium 1 and the intensity of the reference beam 22 can be matched with each other.

The reference beam 22 that is turned at the HM 43 towards the optical recording medium 1 is incident on the optical recording medium 1 after passing through the PBS 33. The recording and reproduction is performed by methods that are described by referring to FIGS. 5 and 6.

Following is the supplementary description of the reproducing system. As it is described by referring to FIG. 6, the diffracted beam 23 that contributes to the reproduction returns to p-polarized light and passes through the PBS 33 in a straight line. Further, a part of the diffracted beam 23 passes through the HM 43 in a straight line and is condensed on a CCD detector 46 by an image formation lens 45 that is provided on an upper side of the HM 43 according to the requirement. The CCD detector 46 converts the distribution of the light intensity corresponding to the interference pattern that is formed in the optical recording layer 4 to an electric signal, thereby resulting in reproduction of the information. The remaining part of the diffracted beam 23 that is passed through the PBS 33 in a straight line is reflected by the HM 43 towards the light source 37. If a monitor is provided at a front end or a back end of the light source 37, the diffracted beam that is reflected from the HM 43 can be detected by this monitor and by driving the light source 37 by performing high frequency superimposition, stability of the beam 20 that is emitted from the light source 37 can be improved.

Following is the description of a servo optical system.

As it is shown in FIG. 7, in the recording and reproducing unit 100, a light source 50 for servo, and the light source 37 for the recording and reproduction are provided separately and generally the two light sources have different wavelengths. Generally, the wavelength of the light source 50 is set to be longer than that of the light source 37. For example, if the wavelength of the light source 37 is 405 nm, the wavelength of the light source 50 is set to be 532 nm, 650 nm, or 780 nm. If the wavelength of the light source 37 is 532, the wavelength of the light source 50 is set to be 650 nm, 780 nm etc.

If the wavelength of the servo beam 24 differs from the wavelength of the beam 20, depending on design of the PBS, the servo beam 40 passes through the PBS 40, HM 41, and PBS 33 one after the other and reaches the reflective layer 6 of the optical recording medium 1. Servo information is recorded as pits etc. in an interface (servo surface) between the substrate 200 and the reflective layer 6. Therefore, the servo beam 24 that is reflected from the reflective layer 6 transmits the servo information.

The servo beam 24 that is reflected from the reflective layer 6 passes through a lens 51 which is disposed according to the requirement and is detected by a quarter split PD 52 for focusing and tracking. The servo beam 24 that is detected is converted to an electric signal and then input to a controller (not shown in the diagram). Operation of a voice coil motor (VCM) 53 is controlled based on an output signal from the controller and the object lens is shifted to a suitable position. Thus, focusing, tracking, and addressing control is performed. The servo beam 24 that is reflected from the servo surface is split by disposing an HM in a plurality of stages. Using each servo beam 24 after splitting, the focusing, tracking, and addressing control is performed independently. A servo beam detection system can be structured similarly to DVD and CD.

Following structure is employed in a case of performing the focusing, tracking, and addressing control.

For example, if the optical recording medium 1 is in a form of a disc, generally, the servo surface undergoes track splitting in a radial direction of the disc and center splitting in a tangential direction of the disc. A sector includes a header which has address information or control information as a pre-pit pattern and a data section which can record user data. For example, the header is equipped with a pit string corresponding to the tracking information and a pit pattern corresponding to the address information one after another along the direction of relative shift of a head of the optical recording medium 1. The pit string and the pit pattern are alienated from each other. In the data section, the surface of the substrate 200 (servo surface) on which the reflective layer 6 is deposited is not equipped with pits and is made to be specular. In other words, when such structure is used, the tracking is performed by sample servo.

If there is unevenness due to grooves for tracking guide in the data section, the recording light and the reference light are scattered in the unevenness. As a result, it is difficult to record and reproduce desired interference pattern. For this reason, in the structure mentioned above, since the data section is specular, there is no difficulty in recording and reproducing the desired interference pattern. However, the sample servo is a technique that is not easily compatible with CD and DVD. Taking into consideration the compatibility with CD and DVD, employing other structures proves to be advantageous in majority of cases.

Thus, the optical recording medium 1 is described by considering the holografic recording by the collinear holographic recording and reproduction in reflection geometry. If the reflective layer 6 is removed from the optical recording medium 1, it is possible to perform transmission holographic recording.

Following is the description of an example of the present invention.

In a first example, the optical recording medium 1 shown in FIG. 2 was prepared by the following method. The optical recording medium 1 in the first example does not include the reflective layer 6.

To start with, 63.83 weight percent (wt %) of di(urethane-acrylate) oligomer, 25.0 wt % of isobornyl acrylate which is a monomer, 10.0 wt % of vinyl 1-naphthoate which is a monomer, 1.0 wt % of bis(2,4-cyclopentadiene-1-yl)-bis(2,6-difluoro-3-(1H-pyrrole-1-yl)-phenyl) titanium which is a photoinitiator, and 0.17 wt % of tertiary-butyl hydroperoxide were mixed together to prepare a photopolymer.

Further, MgF₂ layers of thickness 0.2 μm each were deposited by sputtering on a surface of polycarbonate films 2 and 5 as the inorganic intermediate layers 3 and 7 respectively. The photopolymer was sandwiched between the polycarbonate films 2 and 5 such that the organic recording layer 4 was deposited between the inorganic intermediate layers 3 and 7. The photopolymer was allowed to be cured partly to prepare the optical recording medium 1 that has a structure similar to that in FIG. 2 except in a case where the reflective layer 6 is not provided.

The optical recording medium 1 was mounted in a holographic recording medium for transmission geometry that includes a light source, which has a power of 50 mW and uses laser of wavelength 532 nm. Recording beam that was allowed to pass through an SLM and for which information was superimposed was condensed and irradiated on the optical recording medium 1. At the same time, reference beam was irradiated and interference pattern were recorded. Multiplexing was performed by angular multiplexing in which the angle of the reference beam is changed.

Further, the laser power was reduced to 1/100 and the recorded information was reproduced. As a result, raw bit error rate was not greater than 10⁻⁴ and the recorded information could be reproduced with high accuracy.

In a first example for comparison, the optical recording medium 1 was prepared by the similar method as in the first example except for providing the inorganic intermediate layers 3 and 7. A recording and reproducing test was performed by a similar method as described in the first example. As a result, the raw bit error rate rose to about 10⁻² and the reproducing efficiency was very low as compared to that in the first example.

Optical flatness of the optical recording medium 1 was measured with an interferometer. As a result, a gap of micrometer order was found between the organic recording layer 4 and the polycarbonate films 2 and 5, and the transmittance of light was confirmed to be reduced by 40% of that in the first example.

In a second example, the optical recording medium 1 shown in FIG. 1 was prepared by the following method. In the second example the protective layer 5 was not provided.

To start with, 0.2 wt % of diethyl 1,2-methano[60]-fullerene-61,61-dicarboxylate, which is a charge generating material, 30 wt % of N,N′-diphenyl-N,N′-(2naphthyl)-(1,1′-phenyl)-4,4″-diamine, which is a charge transport material, 10.0 wt % of N,N′-diphenyl-N,N′-(2-naphthyl)-(p-terphenyl)-4,4″-diamine, which is a trapping material, 40.0 wt % of [[4-(dimethyl amino)phenyl]-methylene]-2-methyl-4-nitrobenzene amine, which is a non-linear optical material, and 19.8 wt % of polystyrene were dissolved in toluene and a toluene solution was prepared.

The reflective layer 6 was deposited on a surface of a polycarbonate substrate (having refractive index 1.59 for light of wavelength 532 nm, and thickness 600 μm) 2 on which pre-grooves are formed. The inorganic intermediate layer 3 that has a thickness of 100 nm was deposited by sputtering CaF₂ (refractive index 1.44 for light of wavelength 532) on a side opposite to that of the pre-grooves.

The organic recording layer 4 was deposited by casting the toluene solution on the inorganic intermediate layer 3. Since CaF₂ does not dissolve in the toluene solution, which is a solvent of the organic recording layer 4, an interface between the organic recording layer 4 and the inorganic intermediate layer 3 could be made very flat having unevenness not greater than 100 nm. The film thickness of the organic recording layer 4 was adjusted to be 200 μm.

The optical recording medium 1 that was obtained by the method mentioned above was mounted in the recording and reproducing unit 100 shown in FIG. 7 and recording and reproducing test was performed. In this case, a numerical aperture was adjusted to 0.5 and laser having a wavelength of 532 nm and a power of 50 mW was used as the light source 37. Diameters of the recording beam and the reference beam were 1200 μm at a position on a top surface of the organic recording layer 4 and 900 μm at a position on a bottom surface of the organic recording layer 4. In this case, a shift multiplexing that records different information by allowing a shift of 5 μm each was performed. As a result, the raw bit error rate was not greater than 10⁻⁶ and the recorded information could be reproduced with high accuracy.

In a second example for comparison, the optical recording medium 1 was prepared by the similar method as in the second example except for providing the inorganic intermediate layer 3. Recording and reproducing tests were performed by the similar methods as described in the second example. Since hardly any light incident on the optical recording medium 1 returned back, the reproduction was impossible.

The optical recording medium 1 was sliced together with the substrate 200 and a cross section was observed under a scanning electron microscopy. As a result, a melted (fused) layer with materials from both the layers mixed was found between the organic recording layer 4 and the plastic substrate 200. From this observation, the reason for the reproduction being impossible can be assumed to be the deterioration of an interface between the organic recording layer 4 and the substrate 200 and/or area around the interface.

In a third example, the optical recording medium 1 shown in FIG. 3 was prepared by the following method. To start with 63.83 wt % of ditrimethylol propane tetraacrylate, 25.0 wt % of isobornyl acrylate which is a monomer, 10.0 wt % of vinyl 1-naphthoate, which is a monomer, 1.0 wt % of bis(2,4,6-trimethyl benzoyl)-phenyl phosphene oxide, which is a photoinitiator, and 0.17 wt % of tertiary-butyl hydroperoxide were mixed together to prepare a photopolymer.

ZEONEX film having a thickness of 5 μm manufactured by ZEON CORPORATION, which is a cyclo-olefin polymer, was used as the protective layer 5 and the transparent resin layer 9. MgF₂ layers of thickness 0.2 μm were deposited by sputtering on one surface of the protective layer 5 and the transparent resin layer 9 each as the inorganic intermediate layers 3 and 7. The photopolymer was sandwiched between the polycarbonate films 2 and 5 such that the organic recording layer 4 was deposited between the inorganic intermediate layers 3 and 7. The photopolymer was allowed to be cured partly to prepare a multiple layered film. A roll of the multiple layered film was formed.

Further, the reflective layer 6 was deposited on a surface of a ZEONEX disc substrate (having thickness 600 μm, diameter 12 cmφ) 2 on which the pre-grooves are formed. The multilayered film was stuck on the reverse surface of the ZEONEX disc substrate 2 with hot-melt adhesive. For sticking the multilayered film, about 1 μm thick layer of adhesive was sprayed on both the transparent resin layer 9 and the substrate 200. The multilayered film could be affixed firmly to the substrate 200 by heating and press fitting. The multilayered film was cut to match the size of the disc substrate.

The optical recording medium 1 that was obtained by the method mentioned above was mounted in the recording and generating unit 100 shown in FIG. 7 and recording and generating tests were performed. In this case, a numerical aperture was adjusted to 0.5 and laser having a wavelength 532 nm and power of 50 mW was used as the light source 37. Diameters of the recording beam and the reference beam were 1200 μm at a position on the top surface of the organic recording layer 4 and 900 μm at a position on a bottom surface of the organic recording layer 4. In this case, the shift multiplexing that records different information by allowing a shift of 3 μm each, was performed. Further, the recording was reproduced by reducing the laser power to 1/100. As a result, the raw bit error rate was not greater than 10⁻⁶ and the recorded information could be reproduced with high accuracy.

In a third example for comparison, the optical recording medium 1 was prepared by the similar method as in the third example except for providing the inorganic intermediate layers 3 and 7. Recording and reproducing tests were performed by the similar method as described in the third example. As a result, the raw bit error rate rose to about 10⁻² and the reproducing efficiency was very low as compared to that in the third example.

Optical flatness of the optical recording medium 1 was measured with an interferometer. As a result, a gap of μm order was found to be scattered between the organic recording layer 4 and the protective layer 5 and between the organic recording layer 4 and the transparent resin layer 9, and the transmittance of light was confirmed to be reduced by 20% of that in the third example.

In a fourth example, a holografic recording medium was prepared by using the following method. To start with, tracking grooves that have continuous data area were formed on a stamper. Molten polycarbonate was filled and molded on a light incident side of the servo surface of the reflective surface on which the tracking grooves were formed and the polycarbonate was cooled to form a disc. Further, a 20 nm thick layer of a reflecting film AgNdCu was sputtered on the tracking groove. A 10 nm thick layer of SiO₂ was sputtered as a protective layer. Then, a 0.2 μm thick MgF₂ layer was deposited as an inorganic intermediate layer on the opposite side of the substrate. A 200 μm thick spacer made of polytetrafluoroethylene (Teflon) was placed and a 0.5 mm disc of glass was fixed on a top side. The material for photopolymer that was used in the third example was poured on the glass disc and the holografic recording medium was prepared.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A holographic optical recording medium comprising:
a plastic substrate that has a first surface and a second surface;
a first inorganic intermediate layer formed on the first surface of the plastic substrate; and
an organic recording layer in which information is recorded by using holography, the organic recording layer being formed on the first inorganic intermediate layer.

2. The optical recording medium according to claim 1, further comprising:
an adhesive layer formed between the plastic substrate and the first inorganic intermediate layer;
a first transparent resin layer formed between the adhesive layer and the first inorganic intermediate layer; and
a second inorganic intermediate layer formed on the organic recording layer; and
a second transparent resin layer formed on the second inorganic intermediate layer.

3. The optical recording medium according to claim 1, further comprising a reflective layer formed on the second surface of the plastic substrate.

4. The optical recording medium according to claim 1, wherein the first inorganic intermediate layer has a transmittance not less than 90 percent for a recording light used to record information in the organic recording layer.

5. The optical recording medium according to claim 1, wherein the first inorganic intermediate layer has a transmittance not less than 50 percent for a servo light used for a servo.

6. The optical recording medium according to claim 1, wherein the first inorganic intermediate layer has a thickness not less than 1 nanometer.

7. The optical recording medium according to claim 1, wherein the first inorganic intermediate layer has a thickness not greater than 2000 nanometers.

8. The optical recording medium according to claim 1, wherein the first inorganic intermediate layer includes a material selected from a group consisting of magnesium fluoride, calcium fluoride, zirconium fluoride, palladium fluoride, barium fluoride, cesium bromide, cesium iodide, magnesium oxide, aluminum oxide, silicon oxide, titanium oxide, chromium oxide, zinc oxide, yttrium oxide, zirconium oxide, indium oxide, tin oxide, tellurium oxide, cerium oxide, hafnium oxide, tantalum oxide, boron nitride, silicon nitride, aluminum nitride, zirconium nitride, silicon carbide, zinc sulfide, barium titanate, and diamond.

9. The optical recording medium according to claim 2, wherein the second inorganic intermediate layer includes a material that has a transmittance not less than 90 percent for a recording light used to record information in the organic recording layer.

10. The optical recording medium according to claim 2, wherein the second inorganic intermediate layer has a transmittance not less than 50 percent for a servo light used for a servo.

11. The optical recording medium according to claim 2, wherein the second inorganic intermediate layer has a thickness not less than 1 nanometer.

12. The optical recording medium according to claim 2, wherein the second inorganic intermediate layer has a thickness not greater than 2000 nanometers.

13. The optical recording medium according to claim 2, wherein the second inorganic intermediate layer includes a material selected from a group consisting of magnesium fluoride, calcium fluoride, zirconium fluoride, palladium fluoride, barium fluoride, cesium bromide, cesium iodide, magnesium oxide, aluminum oxide, silicon oxide, titanium oxide, chromium oxide, zinc oxide, yttrium oxide, zirconium oxide, indium oxide, tin oxide, tellurium oxide, cerium oxide, hafnium oxide, tantalum oxide, boron nitride, silicon nitride, aluminum nitride, zirconium nitride, silicon carbide, zinc sulfide, barium titanate, and diamond.

14. The optical recording medium according to claim 1, wherein the organic recording layer includes a photopolymer.

15. A method of manufacturing a holographic optical recording medium, comprising:
forming a multilayered film that includes an organic recording layer that has a first surface and a second surface, a first inorganic intermediate layer on the first surface of the organic recording layer, a first transparent resin layer on the first inorganic intermediate layer, a second inorganic intermediate layer on the second surface of the organic recording medium, a second transparent resin layer on the second organic intermediate layer; and
sticking the multilayered film to a plastic substrate by an adhesive.

16. A method of manufacturing the holographic optical recording medium, comprising:
forming an inorganic intermediate layer on a first surface of a plastic substrate; and
forming an organic recording layer on the inorganic intermediate layer.

17. The method according to claim 16, further comprising:
forming a spacer on the inorganic intermediate layer; and
forming a protective layer on the spacer, wherein
the forming of the organic recording layer includes pouring a material of the organic recording layer between the inorganic intermediate layer and the protective layer to form the organic recording layer.

18. The method according to claim 16, further comprising applying the plastic substrate on a reflective layer on which tracking grooves are formed.

19. The method according to claim 16, further comprising forming a reflective layer on a second surface opposite to the first surface of the plastic substrate.

20. The method according to claim 19, wherein the inorganic intermediate layer is formed after forming the reflective layer.
